(19) United States
(12) Patent Application Publication
(10) Pub. No.: US 2017/0110794 A1
(43) Pub. Date: Apr. 20, 2017

(54) COMPACT ANTENNA WITH MODULAR BEAM APERTURE

(71) Applicant: THALES, COURBEVOIE (FR)

(72) Inventors: Jérôme LORENZO, LA SALVETAT SAINT GILLES (FR); Nicolas FERRANDO, TOURNEFEUILLE (FR); Jérôme BROSSIER, FONSORBES (FR); Benjamin MONTEILLET, TOULOUSE (FR)

(21) Appl. No.: 15/289,404

(22) Filed: Oct. 10, 2016

(30) Foreign Application Priority Data
Oct. 16, 2015 (FR) 1502177

(51) Int. Cl. H01Q 3/20; H01Q 15/14

(52) U.S. Cl. CPC H01Q 3/20; H01Q 15/14

(57) ABSTRACT

A compact antenna with a single beam comprises a main reflector, a secondary reflector, and a controlled actuator assembly acting on the secondary reflector to manage the beam aperture.

### CROSS-REFERENCE TO RELATED APPLICATIONS

This application claims priority to foreign French patent application No. FR 1502177, filed on Oct. 16, 2015, the disclosure of which is incorporated by reference in its entirety.

### FIELD OF THE INVENTION

The invention relates to a compact antenna. It applies notably to the dual axis compact antennas which have to offer a wide aiming field in azimuth and elevation, as well as operations in transmission, reception and/or bipolarization mode. It applies in particular to the space field, to the antennas mounted on satellites.

### BACKGROUND

Wide angular coverage should be understood in aiming terms, i.e. typically with a cone of angular half-width at the apex that can range up to 80°.

The so-called “non-stationary” satellites in low earth orbit have only small volumes for installing antenna equipment items and the mission may demand both high aiming agility and operation of the antenna in transmission and in reception and in bipolarization modes and a generation of several beam apertures.

Antennas with aiming agility that make it possible to ensure all of these functions are not known.

It is known practice to produce a centred parabolic antenna to which is added a flat mirror to obtain the agility in elevation. The assembly rotates about the vertical axis to have the agility in azimuth. Such a parabolic antenna does not allow operation in bipolarization mode nor does it make it possible to avoid the nadir singularity point. Nor does it make possible to generate multiple beam apertures.

It is also known practice to produce a reflector antenna comprising a centred fixed feed in which the reflector has a symmetry of revolution and comprises an aiming mechanism which rotates on two axes, azimuth and elevation. The scanning agility is obtained by reflector movement. However, the symmetry of revolution of the reflector does not allow to maximize the gain of the antenna at the limit of the coverage or control the cross-polarization performance level over a wide field of scan. Furthermore, it is difficult to minimize the height of the antenna because of the position of the feed which is generally very far away from the reflector and the length of the wave guide to reach the feed is significant and is not compatible with bipolarization operation. Nor does such an antenna make it possible to generate multiple beam apertures.

It is also known practice to produce an antenna with dual reflectors comprising a feed placed in front of the secondary reflector in which the scanning agility of the antenna is obtained on an azimuth axis thanks to the movement of the assembly of the two reflectors and feed assembly. The scanning agility of the antenna on an elevation axis is obtained thanks to the movement of the assembly of the two reflectors relative to the feed which remains fixed. The drawbacks are that this antenna solution does not allow operation in bipolarization mode and, furthermore, the volume required for installing kinematics of the antenna is significant. Nor does such an antenna make it possible to generate multiple beam apertures.

It is also known practice to produce an antenna comprising a centred reflector in which the aiming agility is obtained by a set of three linear actuators associated with articulated arms. The bipolarization radiofrequency junction is provided by two co-axial cables. The drawbacks are that this solution induces high volume, a weight and a cost that are significant. Furthermore, the radiofrequency links produced by flexible co-axial cables induce issues of life span. Nor does such an antenna make it possible to generate multiple beam apertures.

### SUMMARY OF THE INVENTION

One aim of the invention is to mitigate the above mentioned problems, and more particularly to provide a compact antenna architecture that makes it possible, over a very wide field of scan to generate, with the same passive scanning antenna, multiple beam apertures.

Also, it is proposed according to one aspect of the invention, a compact antenna with a single beam comprising a main reflector, a secondary reflector or sub-reflector, and a controlled actuator assembly acting on the secondary reflector so as to manage the beam aperture.

Such an antenna makes it possible to generate a plurality of beam apertures.

In one embodiment, the actuator assembly comprises at least one actuator suitable for moving in translation the secondary reflector, called sub-reflector.

Thus, when the actuator assembly comprises at least one actuator suitable for displacing the secondary reflector, the equivalent focal length of the antenna is modified, as is the level of illumination of the feed on the edges of the sub-reflector, which makes it possible to modify the shaping of the antenna pattern and therefore the aperture of the main lobe.

According to one embodiment, the actuator assembly comprises at least one actuator suitable for deforming the secondary reflector or sub-reflector.

Thus, when the actuator assembly comprises at least one actuator suitable for deforming the secondary reflector, the shaping of the sub-reflector is modified, which makes it possible to modify the shaping of the antenna pattern and therefore the aperture of the main lobe.

When the actuator assembly comprises at least one actuator suitable for moving the secondary reflector and at least one actuator suitable for deforming the secondary reflector, the equivalent focal length of the antenna and the shaping of the sub-reflector are modified together: By combining these two effects, this makes it possible to more significantly modify the shaping of the antenna pattern and therefore the aperture of the main lobe. The antenna aperture variation excursion on the main lobe is then maximized.

According to one embodiment, the actuator assembly comprises at least one actuator suitable for moving and deforming the secondary reflector.

Thus, when the actuator assembly comprises an actuator capable of moving and deforming the secondary reflector, installation of the single actuator system makes it possible to graft the modular beam aperture function onto a wide aperture excursion while minimizing the impact on the cost and the complexity of the antenna. Indeed, this single actuator is easy to install because its weight and its volume are very small, and it requires only a single electrical harness to control it.

In one embodiment, the actuators are configured in series.

Configuring the actuators in series makes it possible to control them independently and to simply and accurately manage the displacement and the deformation desired to modify the beam aperture.

According to one embodiment, at least one actuator is linear.

The use of linear actuators, for example step by step type, makes it possible to simply and accurately drive the variation of the beam aperture and also makes it possible for this driving to be reversible (the beam can be opened or closed).

In one embodiment, the secondary reflector has a symmetry of revolution.

### BRIEF DESCRIPTION OF THE DRAWINGS

The invention will be better understood on studying a few embodiments described as non-limiting examples and illustrated by the attached drawings in which:

FIGS. 1a and 1b schematically illustrate an embodiment according to one aspect of the invention in which the actuator assembly comprises only actuators suitable for displacing the secondary reflector;

FIGS. 2a and 2b schematically illustrate an embodiment according to one aspect of the invention in which the actuator assembly comprises only actuators suitable for deforming the secondary reflector;

FIGS. 3a, 3b and 3c schematically illustrate an embodiment according to one aspect of the invention in which the actuator assembly comprises actuators suitable for moving the secondary reflector and actuators suitable for deforming the secondary reflector; and

FIG. 4 schematically illustrates a generalized embodiment of that of FIGS. 3a, 3b and 3c.

### DETAILED DESCRIPTION

In the different figures, the elements that have identical references are identical.

In the following figures, examples of compact antennas are illustrated, very schematically, according to various embodiments of the invention.

Only the elements necessary to the invention are represented, but the compact antenna also comprises the conventional elements necessary to its operation as described, for example, in the FR application whose record number is 14/02674.

In FIGS. 1a and 1b, a conventional compact antenna is represented schematically, and notably comprises a main reflector 2, in this case a plane mirror inclined relative to an elevation axis X, and a secondary reflector 3, in this case a mirror with a surface that is parabolic of revolution. The flat mirror 2 and the parabolic mirror 3 are mounted on a plate 4 of the compact antenna 1 mobile in rotation about the azimuth axis Z.

This first embodiment comprises an actuator 5, for example a linear actuator, suitable for displacing the secondary reflector 3 or parabolic mirror on the elevation axis X.

In the example described, the secondary reflector 3 is displaced to the left on the elevation axis X, between FIGS. 1a and 1b, by controlled action of the actuator 5.

This controlled displacement of the secondary reflector 3 makes it possible to modify the beam aperture of the compact antenna 1.

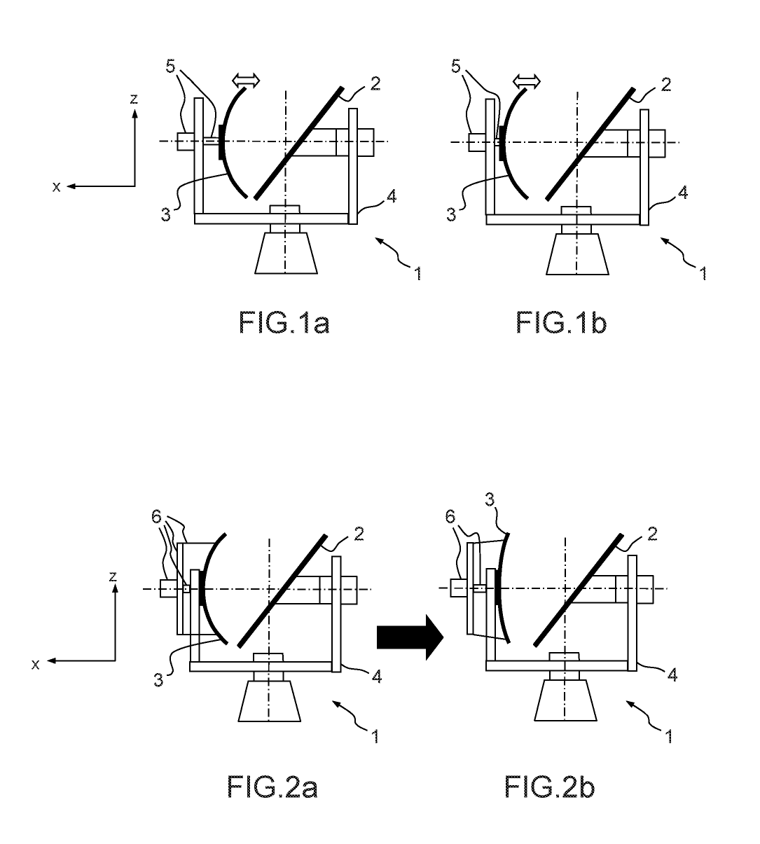

In FIGS. 2a and 2b, a conventional compact antenna is represented schematically and notably comprises a main reflector 2, in this case a flat mirror inclined relative to an elevation axis X, and a secondary reflector 3, in this case a mirror with surface that is parabolic of revolution. The plane mirror 2 and the parabolic mirror 3 are mounted on a plate 4 of the compact antenna 1 rotationally mobile about the azimuth axis Z.

This second embodiment comprises an actuator 6, for example a linear actuator, suitable for deforming the secondary reflector 3 or parabolic mirror on the elevation axis X, or, in other words, modifying the concavity or the shaping thereof.

For example, the actuator 6 can comprise a linear actuator associated with a system of tie rods acting on the periphery of the sub-reflector produced in a flexible material making it possible to reflect the electromagnetic waves.

In the example described, the secondary reflector 3 or parabolic mirror 3 is deformed for example by reduction of the concavity thereof between FIGS. 2a and 2b, by controlled action of the actuator 6.

This controlled deformation of the secondary reflector 3 makes it possible to modify the beam aperture of the compact antenna 1.

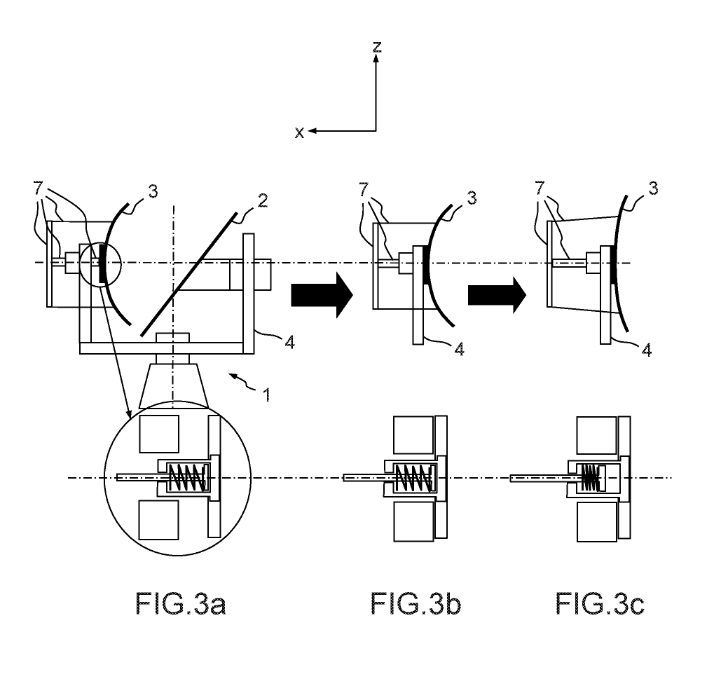

In FIGS. 3a, 3b and 3c, a conventional compact antenna is schematically represented, and notably comprises a main reflector 2, in this case an inclined flat mirror relative to an elevation axis X, and a secondary reflector 3, in this case a mirror with surface that is parabolic of revolution. The flat mirror 2 and the parabolic mirror 3 are mounted on a plate 4 of the compact antenna 1 rotationally mobile about the azimuth axis Z.

This second embodiment comprises an actuator 7, for example a linear actuator suitable for moving and/or deforming the secondary reflector 3 or parabolic mirror on the elevation axis X.

For example, the actuator 7 can comprise a linear actuator assembly with a system of tie rods acting on the periphery of the sub-reflector produced in a flexible material making it possible to reflect the electromagnetic waves, all associated with a single spring system making it possible, with the same linear actuator, to open the shaping of the sub-reflector once this same sub-reflector has been displaced.

In the example described, the secondary reflector 3 or parabolic mirror 3 is displaced then deformed by reduction of the concavity thereof between FIGS. 3b and 3c by controlled action of the actuator 7.

This combination of displacement and controlled deformation of the secondary reflector 3 makes it possible to modify the beam aperture of the compact antenna 1.

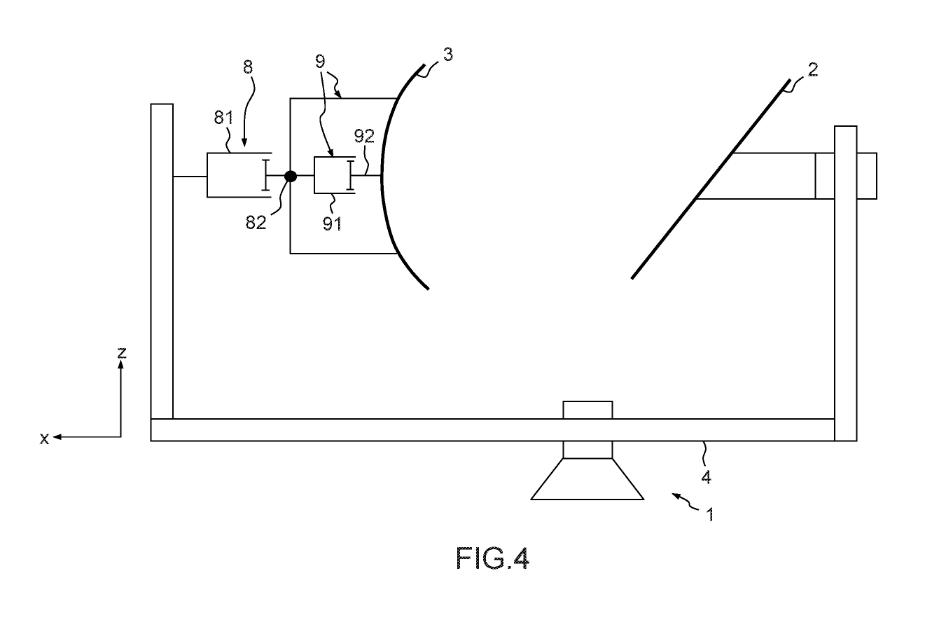

FIG. 4 represents a generalization of the embodiment of FIGS. 3a, 3b and 3c, in which the actuator assembly comprises two actuators 8 and 9 configured in series.

The actuators 8 and 9 can be rotary actuators allowing the desired movements of the secondary reflector 3. Advantageously, the actuators are linear actuators.

The actuator 8 comprises a body 81 and a rod 82 mobile in translation on an axis relative to the body 81, in this case, the elevation axis X. The actuator 8 makes it possible to displace the secondary reflector 3, in this case on the elevation axis X.

Similarly, the actuator 9 comprises a body 91 and a rod 92 mobile in translation on an axis relative to the body 91, in this case the elevation axis X. The actuator 9 makes it possible to deform the secondary reflector 3, in this case modify the concavity of the secondary reflector 3 given the rigid connection between the actuator 9 and the secondary reflector 3. This actuator 9 can comprise a simple passive spring system.

The actuators 8 and 9 are driven so as to move in translation, for each, the rod, relative to the respective body. The body 81 is secured to the plate 4 of the antenna 1. The actuators 8 and 9 are configured in series so that the body 91 is secured to the rod 82. The rod 92 is secured to the secondary reflector 3.

To simplify the construction of the device, the axes are advantageously the same, in this case the elevation axis X. Other arrangements are possible in the context of the invention. As a variant, the axes of the two actuators 8 and 9 can be parallel and at a distance from one another.

1. A compact antenna with a single beam comprising a main reflector, a secondary reflector, and a controlled actuator assembly acting on the secondary reflector to manage the beam aperture.

2. The antenna according to claim 1, wherein the actuator assembly comprises at least one actuator suitable for moving in translation the secondary reflector.

3. The antenna according to claim 1, wherein the actuator assembly comprises at least one actuator suitable for deforming the secondary reflector.

4. The antenna according to claim 1, wherein the actuator assembly comprises at least one actuator suitable for displacing and deforming the secondary reflector.

5. The antenna according to claim 2, wherein the actuators are configured in series.

6. The antenna according to claim 1, wherein at least one actuator is linear.

7. The antenna according to claim 1, wherein the secondary reflector has a symmetry of revolution.

8. The antenna according to claim 1, wherein the actuator assembly comprises at least one step by step type actuator.
